(19) United States
(12) Patent Application Publication
(10) Pub. No.: US 2017/0339764 A1
(43) Pub. Date: Nov. 23, 2017

(54) LIGHTING CONTROL SYSTEM

(71) Applicant: PANASONIC INTELLECTUAL PROPERTY MANAGEMENT CO., LTD., Osaka (JP)

(72) Inventor: Ryosuke NAKAMURA, Kanagawa (JP)

(21) Appl. No.: 15/586,872

(22) Filed: May 4, 2017

(30) Foreign Application Priority Data
May 19, 2016 (JP) 2016-100451

(51) Int. Cl. H05B 33/08

(52) U.S. Cl. CPC H05B 33/0854

(57) ABSTRACT

The lighting control system includes a lighting unit configured to emit light to a lighting space; an imaging unit configured to obtain image data of the lighting space; and a controller configured to control the lighting unit based on the image data obtained by the imaging unit. The controller includes: a person determiner configured to determine whether a person is staying in the lighting space, based on the image data; a shadow determiner configured to, when the person determiner determines that the person is staying in the lighting space, determine whether a shadow is extending from the person, based on the image data; and a dimmer configured to, when the shadow determiner determines that the shadow is extending from the person, increase a dimming rate of the lighting unit.

This application claims foreign priority based on Japanese Patent Application No. 2016-100451, filed on May 19, 2016, the entire content of which is herein incorporated by reference.

### TECHNICAL FIELD

The present disclosure relates to a lighting control system which performs dimming of a lighting unit.

### BACKGROUND

There has been conventionally known a lighting control system which turns on a lighting unit when determining that a person is staying in a lighting space, by using image data captured by an image sensor. By using the image data obtained by the image sensor, the lighting control system first determines whether the person is staying in the lighting space and calculates illuminance data of the lighting space. Then, based on the results of these determination and calculation, the lighting control system adjusts a dimming rate of the lighting unit.

One example of arts related to the above-described background is disclosed in Japanese Patent Application Publication No. 2015-185364.

### SUMMARY

Generally, when a person exists in a lighting space into which light from the outside comes, a shadow of the person due to the light from the outside is formed in the lighting space. In such a case, although an illuminance in a region where the shadow is formed is low, an average illuminance of a surface illuminated with light (illumination surface) in the lighting space as a whole is high due to an effect of the light from the outside. Accordingly, the conventional lighting control system adjusts the dimming rate of the lighting unit to a low value. The conventional lighting control system thus has a problem that objects are less visible in the region where the shadow of the person is formed. For example, there is a case where a desk and a chair are placed in a lighting space such that the person can sit on the chair near a window with his/her back facing the window. In this case, since the shadow of the person is formed on a work space on the desk, the illuminance in the work space is low. Hence, in such a case, there is a problem that the person sitting on the chair has difficulty in seeing letters in books on the desk and images in a display on the desk.

The present subject matter has been made in view of such a problem of the conventional technique. One of the objectives of the present diclosure is to provide a lighting control system which is less likely to have an adverse effect of a shadow of a person.

In order to solve the problem described above, a lighting control system of a first aspect of the present disclosure comprises: a lighting unit that emits light to a lighting space; an imaging unit that obtains image data of the lighting space; and a controller that controls the lighting unit based on the image data obtained by the imaging unit, wherein the controller includes: a person determiner that determines whether a person is staying in the lighting space, based on the image data; a shadow determiner that, when the person determiner determines that the person is staying in the lighting space, determines whether a shadow is extending from the person, based on the image data; and a dimmer that, when the shadow determiner determines that the shadow is extending from the person, increases brightness of the light emitted from the lighting unit by increasing a dimming rate of the lighting unit.

A lighting control system of a second aspect of the present disclosure comprises: a plurality of lighting units, each emitting light to corresponding one of a plurality of subspaces constituting a lighting space; an imaging unit that obtains image data of the lighting space; a controller that controls the plurality of lighting units based on the image data obtained by the imaging unit, wherein the controller includes: a data storage that stores association data in which the plurality of lighting units are associated with the plurality of subspaces, respectively, a person determiner that determines whether a person is staying in the lighting space, based on the image data, a shadow determiner that, when the person determiner determines that the person is staying in the lighting space, determines whether a shadow is extending from the person, based on the image data and then, when determining that the shadow is extending from the person, identifies in which of the plurality of subspaces the shadow is extending from the person, based on the image data, and a dimmer that increases a dimming rate of the lighting unit emitting light to the subspace identified by the shadow determiner from among the plurality of subspaces, based on the association data, and thereby, increases brightness of the light emitted from the corresponding one of the plurality of lighting units.

A light control unit that controls a lighting unit to emit light to a lighting space of a third aspect of the present disclosure, wherein the light control unit comprises: an imaging unit that obtains image data of the lighting space; and a controller that controls the lighting unit based on the image data obtained by the imaging unit, wherein the controller controls the light unit so as to increase brightness of the light emitted from the lighting unit, in a case where the controller determines based on the image data that a person is staying in the lighting space and that a shadow extends from the person.

The present subject matter can suppress the adverse effect of the shadow of the person.

### BRIEF DESCRIPTION OF THE DRAWINGS

FIG. 1 is a horizontal cross-sectional schematic diagram of a lighting space in which a lighting control system in Embodiment 1 of the present disclosure is installed.

FIG. 2 is a vertical cross-sectional schematic diagram of the lighting space in which the lighting control system in Embodiment 1 of the present disclosure is installed.

FIG. 3 is a block diagram for explaining functions of a controller in the lighting control system in Embodiment 1 of the present disclosure.

FIG. 4 is a flowchart of a dimming process executed by the controller in the lighting control system in Embodiment 1 of the present disclosure.

FIG. 5 is a horizontal cross-sectional schematic diagram of a lighting space in which a lighting control system in Embodiment 2 of the present disclosure is installed.

FIG. 6 is a block diagram for explaining functions of a controller in the lighting control system in Embodiment 2 of the present disclosure.

FIG. 7 is a flowchart of a dimming process executed by the controller in the lighting control system in Embodiment 2 of the present disclosure.

FIG. 8 is a horizontal cross-sectional schematic diagram of a lighting space in which a lighting control system in Embodiment 3 of the present disclosure is installed.

FIG. 9 is a vertical cross-sectional schematic diagram illustrating a structure around lighting units in the lighting space in which the lighting control system in Embodiment 3 of the present disclosure is installed.

### DETAILED DESCRIPTION OF THE PREFERRED EMBODIMENTS

A lighting control system in each of embodiments will be described below with reference to the drawings.

In the embodiments, portions denoted by the same reference numerals are assumed to have the same functions, unless otherwise noted. Accordingly, descriptions of the functions of the portions denoted by the same reference numerals are not repeated unless necessary.

### Embodiment 1

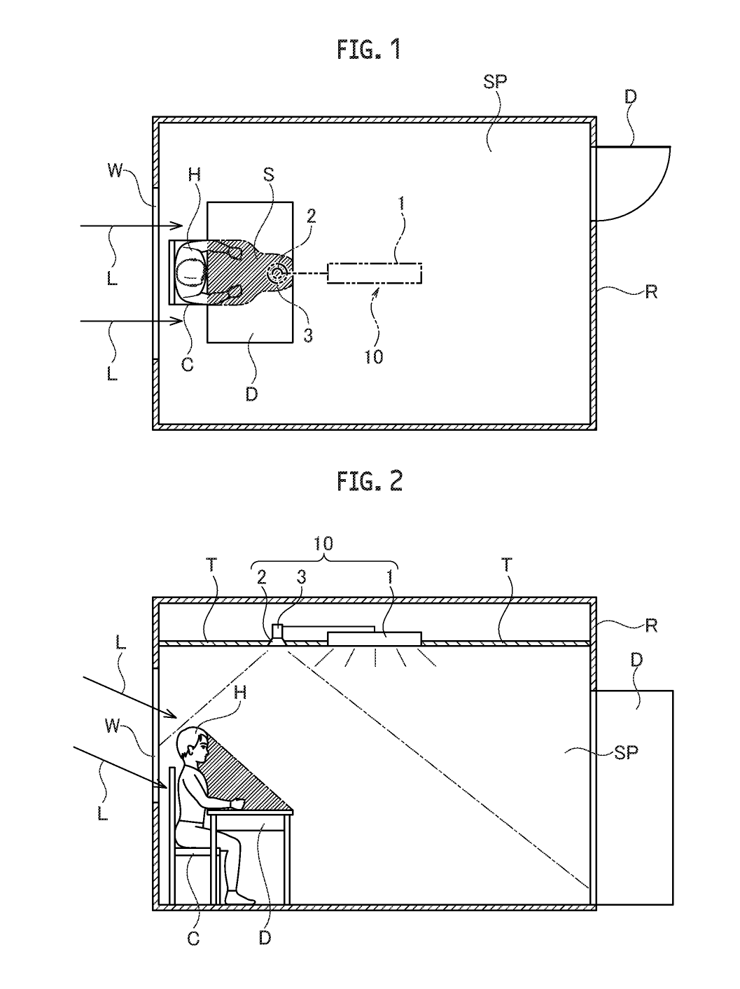

A lighting control system in Embodiment 1 is described by using FIGS. 1 to 4.

As illustrated in FIGS. 1 and 2, the lighting control system 10 of the embodiment is used to emit light to a lighting space SP surrounded by an enclosure R. A door D and a window W are provided in the enclosure R. A sunlight L enters the lighting space SP from the outside through the window W. A desk D and a chair C are set in the lighting space SP. A person H is sitting on the chair C with his/her back facing the window W. Accordingly, a shadow S is formed on a top surface of the desk D which is in the direction of the visual line of the person H. When the shadow S is formed on the top surface of the desk D as described above, the person H feels that letters in documents and the like placed on the top surface of the desk D are difficult to read. Moreover, when a display of a personal computer is placed on the top surface of the desk D, a shadow may be also formed on a screen of the display. Also in this case, the person H feels that letters and the like displayed on the display are difficult to read. The lighting control system 10 of the embodiment has the configuration described below to reduce such adverse effects of the shadow S.

As illustrated in FIGS. 1 and 2, the lighting control system 10 of the embodiment includes a lighting unit 1, an imaging unit 2, and a controller 3. As illustrated in FIG. 2, the lighting control system 10 is attached to a ceiling portion T. The lighting unit 1 has a light source such as a light emitting diode (LED), and emits light to the lighting space SP surrounded by the enclosure R. The imaging unit 2 obtains image data of the lighting space SP. In the embodiment, the imaging unit 2 is assumed to be capable of obtaining image data of a region including an entire floor surface of the lighting space SP. The controller 3 controls a light emitting state of the lighting unit 1, based on the image data obtained by the imaging unit 2.

Communication between the lighting unit 1 and the controller 3 and communication between the imaging unit 2 and the controller 3 may be communication using wires or wireless communication. In the embodiment, the imaging unit 2 and the controller 3 are integrated as one lighting control unit.

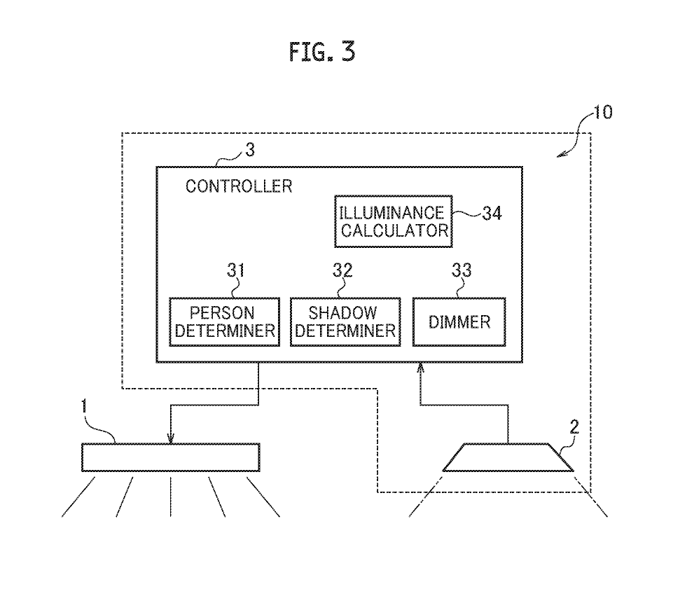

As illustrated in FIG. 3, the controller 3 includes a person determiner 31, a shadow determiner 32, and a dimmer 33. The person determiner 31 determines whether the person H is staying in the lighting space SP, based on the image data obtained by the imaging unit 2. The shadow determiner 32 determines whether the shadow S is extending from the person H, based on the image data obtained by the imaging unit 2, when the person determiner 31 determines that the person H is staying in the lighting space SP. The dimmer 33 increases a dimming rate of the lighting unit 1 (i.e., making the lighting unit 1 brighter, that is, increasing the brightness of the light emitted from the lighting unit 1) when the person determiner 31 determines that the person H is staying in the lighting space SP and the shadow determiner 32 determines that the shadow S is extending from the person H. This configuration can suppress an adverse effect of the shadow S of the person H that the person H feels difficultly in seeing letters in a document placed on the desk D, images in a display on the desk D, and objects on the desk D.

In the embodiment, whether the shadow S extends from the person H is determined by using a difference between the entire images obtained by the imaging unit 2 and by using edge images extracted from the image data obtained by the imaging unit 2.

The controller 3 first stores image data obtained by the imaging unit 2 in which no person H exists in the entire image. Then, the controller 3 calculates a difference between this entire image and the next entire image obtained by the imaging unit 2 at a certain cycle. The controller 3 determines whether the person H exists in the lighting space SP, based on the calculated difference. In the embodiment, the person determiner 31 determines that the person H exists in the lighting space SP when there is a difference between the entire image obtained by the imaging unit 2 in the initial stage and the entire image obtained by the imaging unit 2 thereafter.

Moreover, when the person H exists in the lighting space SP, the person determiner 31 determines whether the person H is moving or staying at one place. Whether the person H is moving or staying at one place is determined from whether an image portion recognized as the person H has moved by a certain distance within a certain period. In other words, whether the person H is moving or staying in one place is determined based on the difference between the images.

Furthermore, the controller 3 obtains the edge images in the image data obtained by the imaging unit 2. Then, the shadow determiner 32 determines whether the shadow S is extending from the person H, based on the obtained edge images. The edge images can be classified into a clear edge image and an unclear edge image. The clear edge image is assumed to be an edge image of an actual object such as the person H, the desk D, the chair C, or the like. The unclear edge image is assumed to be an edge image of the shadow S. The shadow determiner 32 can thus distinguish the image of the shadow S in an integrated image of the person H and the shadow S, by utilizing the edge images.

Accordingly, when the unclear edge image exists among the edge images, the shadow determiner 32 determines that this unclear edge image is the shadow S. In the embodiment, the shadow determiner 32 determines that the shadow S is extending from the person H when the unclear edge image of the shadow S exists adjacent to the clear edge image of the person H. A threshold between the clear edge image and the unclear edge image is determined in advance based on results of comparison between the edge images of actual objects such as a person and a desk and the edge images of shadows which are obtained in experiments in a factory.

Note that, when the images obtained by the imaging unit 2 are color images, the person H and the shadow S may be identified by colors.

As illustrated in FIG. 3, the controller 3 includes an illuminance calculator 34 which calculates an average illuminance of an illumination surface in the lighting space SP, based on the image data obtained by the imaging unit 2. In the embodiment, the dimmer 33 adjusts the dimming rate of the lighting unit 1 such that the average illuminance calculated by the illuminance calculator 34 becomes a predetermined value necessary for the person H. Under this condition, the dimmer 33 increases the dimming rate only when the person determiner 31 determines that the person H is staying in the lighting space SP and the shadow determiner 32 determines that the shadow S is extending from the person H. Accordingly, when no shadow S is extending from the staying person H, the average illuminance of the illumination surface in the lighting space SP can be maintained at the predetermined value necessary for the person H. Note that the predetermined value may be one value or any value within a predetermined range between an upper limit value and a lower limit value.

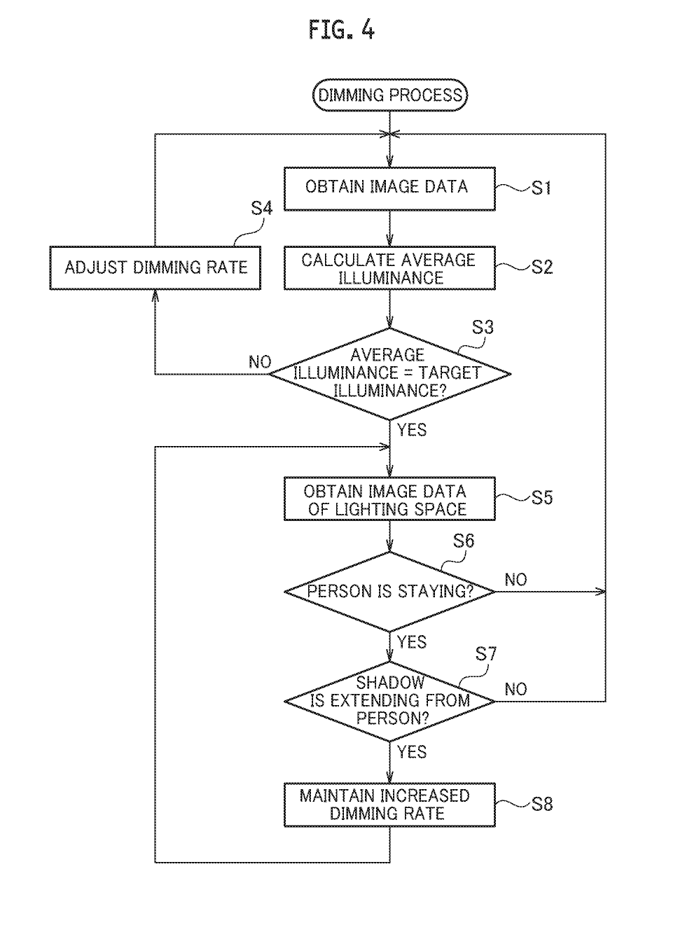

As illustrated in FIG. 4, in step S1 of a dimming process executed by the controller 3 of the lighting control system in the embodiment, the controller 3 first obtains the image data of the lighting space SP captured by the imaging unit 2. The obtained image data is sent to each of the person determiner 31, the shadow determiner 32, and the illuminance calculator 34.

Next, in step S2, the illuminance calculator 34 calculates the average illuminance of the illumination surface in the lighting space SP. In step S3, the dimmer 33 determines whether the average illuminance of the illumination surface in the lighting space SP is a target illuminance, that is, the predetermined value necessary for the person H. An operation is performed before the use of the lighting control system 10 to store the predetermined value necessary for the person H in the controller 3, specifically for example, in the illuminance calculator 34. The predetermined value necessary for the person H may be set in advance by the person H or set by a person other than the person H when the lighting control system 10 is shipped from the factory or installed in the lighting space SP.

The average illuminance of the illumination surface in the lighting space SP is sometimes not the predetermined value necessary for the person H in step S3. In this case, in step S4, the dimmer 33 adjusts the dimming rate of the lighting unit 1 such that the average illuminance of the illumination surface in the lighting space SP becomes the predetermined value necessary for the person H. Specifically, every time step S4 is executed, the dimmer 33 gradually increases or decreases the dimming rate of the lighting unit 1 by a certain amount until the average illuminance reaches the aforementioned predetermined value.

Meanwhile, when the average illuminance of the illumination surface in the lighting space SP is the predetermined value necessary for the person H in step S3, the controller 3 obtains the image data of the lighting space SP captured by the imaging unit 2 again in step S5.

Next, in step S6, the person determiner 31 determines whether the person H is staying in the lighting space SP, based on the image data. The person determiner 31 determines whether the person H exists, based on the difference between the entire image captured in the initial stage and the entire image captured at this moment. Moreover, whether the person H is staying in one place is determined by determining whether the image portion recognized to be the person H in the image data stays within a certain position range for a certain period.

When the person determiner 31 determines that the person H is staying in the lighting space SP in step S6, the shadow determiner 32 determines whether the shadow S is extending from the person H in step S7. The shadow determiner 32 determines whether the shadow S is extending from the person H, by determining whether the unclear edge image adjacent to the person H exists among the edge images extracted from the image data obtained by the imaging unit 2. When the shadow determiner 32 determines that the shadow S is extending from the person H in step S7, the dimmer 33 increases the dimming rate of the lighting unit 1 and maintains the increased dimming rate in step S8. In other words, in the case where the steps S5 to S8 are repeated, the dimmer 33 increases the dimming rate in the first step S8 and maintains the increased dimming rate in the second step S8 and all the steps S8 after the second step 8.

The dimmer 33 may increase the dimming rate to a predetermined value which is, for example, a dimming rate in night where there is no adverse effect of the sunlight, such as, for example, 80%, and maintain the increased dimming rate. Alternatively, the dimmer 33 may increase the dimming rate immediately before the increase by a predetermined increase value such as, for example, 20%, and maintain the increased dimming rate.

Meanwhile, when the shadow determiner 32 determines that no person H is staying in the lighting space SP in step S6, the controller 3 returns to step S1 and obtains the image data of the lighting space SP captured by the imaging unit 2. Likewise, when in step S7 the shadow determiner 32 determines that no shadow S is extending from the person H, the controller 3 returns to step S1 and obtains the image data of the lighting space SP captured by the imaging unit 2.

Note that steps S1 to S4 are control for adjusting the dimming rate when no shadow S is extending from the person H. In steps S1 to S4, when there is no adverse effect of the shadow S, the dimming rate of the lighting unit 1 continues to be adjusted such that the average illuminance of the illumination surface in the lighting space SP becomes the predetermined value.

The lighting unit 1 of the embodiment described above may be formed of one lighting device or a plurality of lighting devices. When the lighting unit 1 is formed of a plurality of lighting devices, the dimmer 33 may be any type of dimmer as long as the dimmer 33 increases the dimming rate of the lighting unit 1 as a whole when the shadow S is extending from the person H. In this case, the controller 3 may accordingly increase the dimming rates of all the plurality of lighting devices or increase the dimming rate of any one of the plurality of lighting devices when the shadow S is extending from the person H.

### Embodiment 2

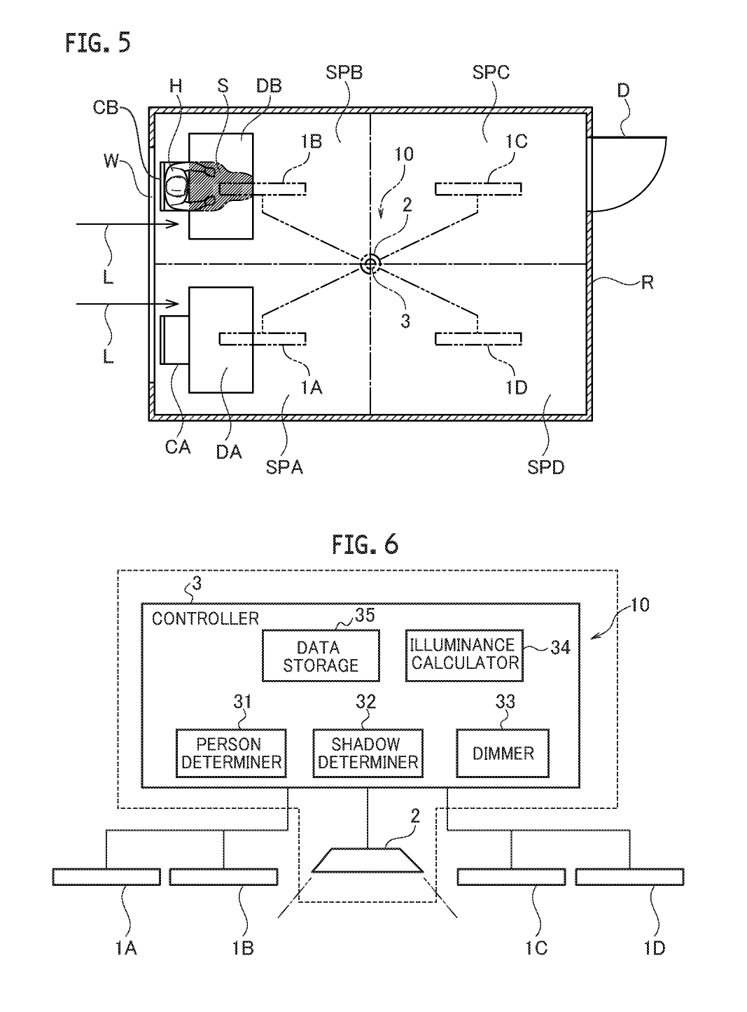

A lighting control system in Embodiment 2 will be described by using FIGS. 5 to 7.

As illustrated in FIG. 5, in the embodiment, one lighting space surrounded by an enclosure R is considered to be composed of one group of a plurality of subspaces SPA, SPB, SPC, and SPD. A lighting control system 10 in the embodiment is set to emit light to the group of the subspaces SPA, SPB, SPC, and SPD surrounded by the enclosure R. A door D and a window W are provided in the enclosure R as in Embodiment 1. A sunlight L enters the subspaces SPA, SPB, SPC, and SPD from the outside through the window W. A desk DA and a chair CA are set in the subspace SPA. A desk DB and a chair CB are set in the subspace SPB. A person H is sitting on the chair CB with his/her back facing the window W. Accordingly, a shadow S is extending from the person H onto a top surface of the desk DB which is in the direction of the visual line of the person H. Meanwhile, no shadow S is formed on the desk DA corresponding to the chair CA on which no person H is staying. In such a situation, it is preferable to suppress an adverse effect of the shadow S formed on the top surface of the desk DB without changing the illuminance in areas other than the periphery of the desk DB. To this end, the lighting control system 10 of the embodiment has the following configuration.

The lighting control system 10 of the embodiment includes a plurality of lighting units 1A, 1B, 1C, and 1D and an imaging unit 2. The plurality of lighting units 1A, 1B, 1C, and 1D emit light to the plurality of subspaces SPA, SPB, SPC, and SPD, respectively. The imaging unit 2 obtains image data of the one lighting space consisting of the plurality of subspaces SPA, SPB, SPC, and SPD as a whole. The controller 3 adjusts dimming rates of the lighting units 1A, 1B, 1C, and 1D based on the image data obtained by the imaging unit 2.

Also in the present embodiment, communication between each of the lighting units 1 and the controller 3 as well as communication between the imaging unit 2 and the controller 3 may be communication using wires or wireless communication. Also in the embodiment, the imaging unit 2 and the controller 3 are integrated as one lighting control unit.

As illustrated in FIG. 6, the controller 3 of the embodiment includes a data storage 35, a person determiner 31, and a shadow determiner 32. The data storage 35 stores pieces of association data in which the plurality of lighting units 1A, 1B, 1C, and 1D are associated with the plurality of subspaces SPA, SPB, SPC, and SPD, respectively. In each piece of association data, one lighting unit is associated with one subspace to which the one lighting unit emits light. The person determiner 31 determines whether the person H is staying in the lighting space, based on the image data obtained by the imaging unit 2. The shadow determiner 32 determines whether the shadow S is extending from the person H, based on the image data, when the person determiner 31 determines that the person H is staying in the lighting space. Then, when determining that the shadow S is extending from the person H, the shadow determiner 32 identifies in which of the plurality of subspaces SPA, SPB, SPC, and SPD the shadow S is extending from the person H.

In the embodiment, the shadow S is extending from the person H in the subspace SPB. Accordingly, the dimmer 33 increases the dimming rate of the lighting unit 1B emitting light to the subspace SPB in which the shadow S is extending from the person H, based on the association data. Generally, the controller 3 increases the illuminance in any of the plurality of subspaces SPA, SPB, SPC, and SPD to suppress the adverse effect of the shadow S. To this end, the controller 3 increases the dimming rate of at least one of the plurality of lighting units 1A, 1B, 1C, and 1D associated with the subspace in which the illuminance is to be increased.

In the configuration described above, for example, it is possible to increase only the dimming rate of the lighting unit 1B emitting light to the subspace SPB in which the shadow S is extending from the person H. Accordingly, it is possible to prevent unnecessary power consumption caused by increasing the dimming rates of the lighting units 1A, 1C, and 1D emitting light to the subspaces SPA, SPC, and SPD in which no shadow S is extending from the person H.

The dimmer 33 may increase the dimming rate to a predetermined value which is, for example, a dimming rate in night where there is no adverse effect of the sunlight, such as, for example, 80%. Alternatively, the dimmer 33 may increase the dimming rate immediately before the increase by a predetermined increase value such as, for example, 20%.

The controller 3 includes an illuminance calculator 34 which calculates an average illuminance of an illumination surface in each of the plurality of subspaces SPA, SPB, SPC, and SPD, based on the image data. The dimmer 33 adjusts the dimming rates of the plurality of lighting units 1A, 1B, 1C, and 1D such that the average illuminance of the illumination surface in each of the plurality of subspaces SPA, SPB, SPC, and SPD becomes a predetermined value necessary for the person H. Under this condition, the dimmer 33 increases the dimming rate of the lighting unit emitting light to the subspace SPB identified to have the shadow S extending from the person H. Accordingly, the average illuminances of the illumination surfaces in the subspaces SPA, SPC, and SPD in which no shadow S is extending from the staying person H can be maintained at the predetermined value necessary for the person H.

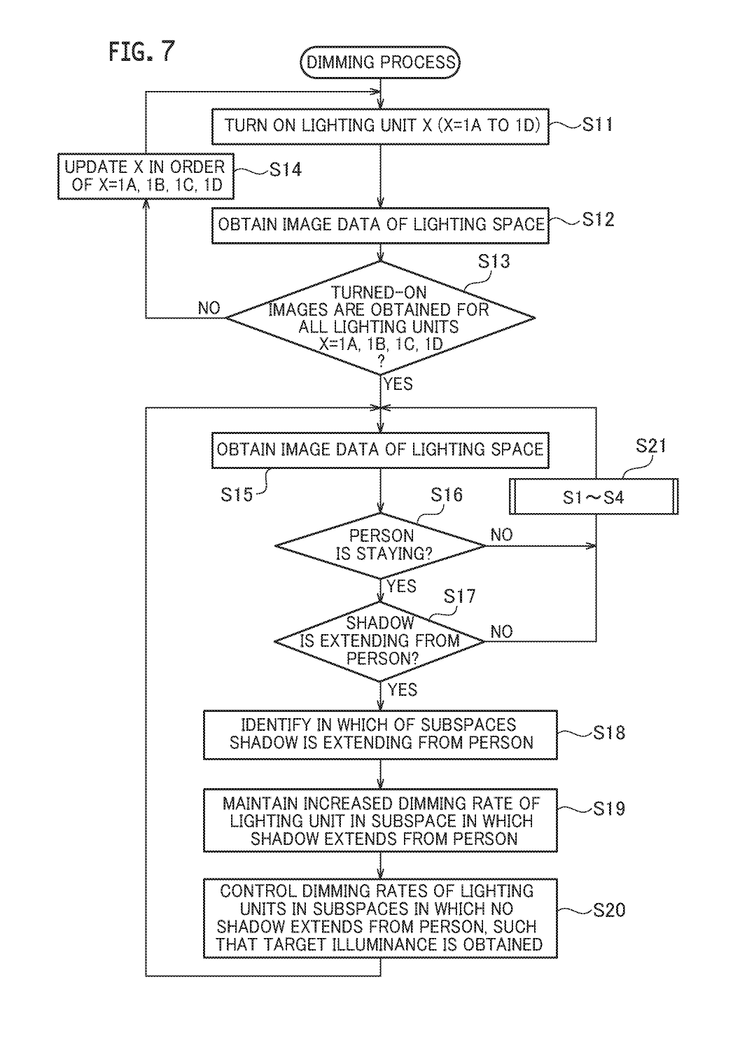

As illustrated in FIG. 7, in a dimming process executed by the controller 3 of the lighting control system 10 in the embodiment, first, processes of step S11 to step S14 are repeated four times. Every time the cycle of steps S11 to S14 is performed, one of the lighting units 1A, 1B, 1C, and 1D is turned on in step S11. One of the lighting units 1A, 1B, 1C, and 1D is turned on in this order every time step S11 is executed. Light is thereby emitted to a corresponding one of the subspaces SPA, SPB, SPC, and SPD in this order.

In step S12, the controller 3 obtains image data of the lighting space captured when one of the lighting units 1A, 1B, 1C, and 1D is turned on, as image data of the lighting space captured by the imaging unit 2. Four types of image data each captured when one of the lighting units 1A, 1B, 1C, and 1D is turned on are sequentially obtained by repeating the processes of step S11 to step S14 four times. The controller 3 stores the four types of image data in the data storage 35. The controller 3 determines the association relationships between the lighting units 1A, 1B, 1C, and 1D and the subspaces SPA, SPB, SPC, and SPD, based on the four types of image data. The data storage 35 stores the association data capable of identifying to which one of the subspaces SPA, SPB, SPC, and SPD each of the lighting units 1A, 1B, 1C, and 1D emits light.

In step S13, the controller 3 determines whether the imaging unit 2 has obtained the image data with every one of the lighting units 1A, 1B, 1C, and 1D turned on. In step 13, there is a case where the controller 3 determines that the imaging unit 2 has not obtained the image data with every one of the lighting units 1A, 1B, 1C, and 1D turned on. In this case, the lighting unit to be turned on next is updated in step S14. For example, when the lighting unit 1A is on, the lighting unit 1A is turned off and then a process for turning on the lighting unit 1B is executed. Then, in steps S11 to S13, the lighting unit 1B to be turned on subsequent to the previously turned-on lighting unit 1A is turned on and the imaging unit 2 obtains the image data of the lighting space while the lighting unit 1B is on. The data storage 35 thereby stores the association data indicating that the lighting unit 1A emits light to the subspace SPA, the lighting unit 1B emits light to the subspace SPB, the lighting unit 1C emits light to the subspace SPC, and the lighting unit 1D emits light to the subspace SPD.

Meanwhile, there is a case where the controller 3 determines that the imaging unit 2 has obtained the image data with every one of the lighting units 1A, 1B, 1C, and 1D turned on in step S13. In this case, in step S15, the controller 3 obtains the image data of the lighting space SP captured by the imaging unit 2 again. The obtained image data is sent to the person determiner 31, the shadow determiner 32, and the illuminance calculator 34.

Next, in step S16, the person determiner 31 determines whether the person H is staying in the lighting space SP, based on the image data obtained in step S15. The person determiner 31 determines whether the person H is staying by determining whether an image portion recognized to be the person H in the image data stays within a certain position range for a certain period. When the person determiner 31 determines that the person H is staying in the lighting space SP in step S16, the shadow determiner 32 determines whether the shadow S is extending from the person H in step S17.

There is a case where the shadow determiner 32 determines that the shadow S is extending from the person H in step S17. In this case, in step S18, the controller 3 identifies in which of the subspaces SPA, SPB, SPC, and SPD the shadow S is extending from the person H, based on the image data obtained by the imaging unit 2 in step S15. In the embodiment, the subspace SPB is assumed to be the subspace in which the shadow S is extending from the person H. In step S19, the dimmer 33 thus increases the dimming rate of the lighting unit 1B emitting light to the subspace SPB determined to have the shadow S extending from the person H, and maintains the increased dimming rate. In this case, the controller 3 selects the lighting unit 1B associated with the subspace SPB, based on the association data prepared in steps S11 to S14.

Next, in step S20, the controller 3 adjusts the dimming rates of the lighting units 1A, 1C, and 1D associated with the subspaces SPA, SPC, and SPD in which no shadow S is extending from the person H, such that the average illuminances in the subspaces SPA, SPC, and SPD become the illuminance necessary for the person H (target illuminance). In this case, the controller 3 selects and controls the lighting units 1A, 1C, and 1D associated with the subspaces SPA, SPC, and SPD, based on the association data prepared in steps S11 to S14. In step S20, the same processes as those of steps S1 to S4 in FIG. 4 of Embodiment 1 are executed for the subspaces SPA, SPC, and SPD. Specifically, the dimming rates of the lighting units 1A, 1C, and 1D are adjusted such that the average illuminances in the three subspaces of SPA, SPC, and SPD become the predetermined illuminance necessary for the person H.

The dimmer 33 may increase the dimming rate to a predetermined value which is, for example, a dimming rate in night where there is no adverse effect of the sunlight, such as, for example, 80%. Alternatively, the dimmer 33 may increase the dimming rate immediately before the increase by a predetermined increase value such as, for example, 20%.

Meanwhile, there are cases where the person determiner 31 determines that no person H is staying in the lighting space in step S16, or the shadow determiner 32 determines that no shadow S is extending from the person H in step S17. In these cases, in step S21, the dimmer 33 adjusts the dimming rates of the lighting units 1A, 1B, 1C, and 1D such that the average illuminance of the subspaces SPA, SPB, SPC, and SPD as a whole becomes the predetermined value necessary for the person H. In step S21, the same processes as those of steps S1 to S4 in FIG. 4 of Embodiment 1 are executed for all of the subspaces SPA, SPB, SPC, and SPD. Specifically, the light dimming rates of the lighting units 1A, 1B, 1C, and 1D are adjusted such that the average illuminance in the subspaces SPA, SPB, SPC, and SPD as a whole becomes the predetermined illuminance necessary for the person H. After step S21, the process returns to step S15 and the imaging unit 2 obtains the image data of the lighting space which is the group of the subspaces SPA, SPB, SPC, and SPD again.

### Embodiment 3

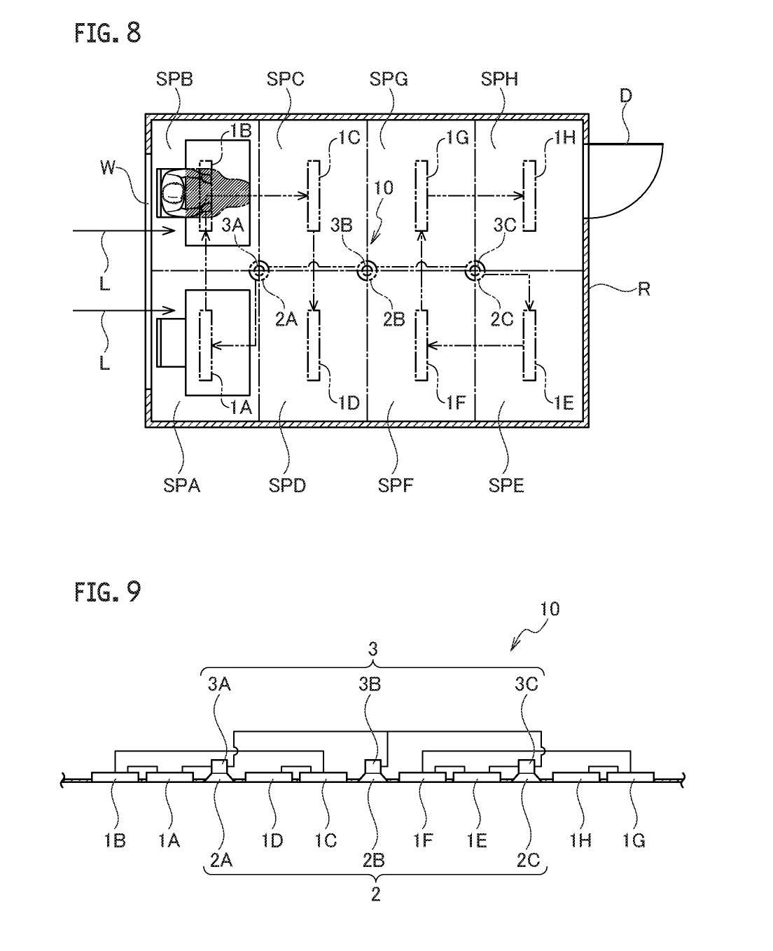

A lighting control system in Embodiment 3 will be described by using FIG. 8.

The lighting control system 10 in the embodiment has substantially the same configuration as that of the lighting control system 10 in Embodiment 2. In the following description, differences between the configuration of the lighting control system 10 in the embodiment and the configuration of the lighting control system 10 in Embodiment 2 are mainly described.

As illustrated in FIG. 8, in the embodiment, a lighting space surrounded by an enclosure R is assumed to be composed of one group of a plurality of subspaces SPA, SPB, SPC, SPD, SPE, SPF, SPG, and SPH. Specifically, the lighting control system 10 in the embodiment is set to emit light to the group of subspaces SPA, SPB, SPC, SPD, SPE, SPF, SPG, and SPH surrounded by the enclosure R.

As illustrated in FIG. 8, in the lighting control system 10 in the embodiment, the imaging unit 2 includes first image sensors 2A and 2C and a second image sensor 2B. The controller 3 includes first controllers 3A and 3C and a second controller 3B. The first image sensor 2A and the first controller 3A are integrated to be used as a first lighting control unit for detecting a person H and a shadow S. The first image sensor 2C and the first controller 3C are also integrated to be used as the first lighting control unit for detecting the person H and the shadow S. Meanwhile, the second image sensor 2B and the second controller 3B are integrated to be used as a second lighting control unit for detecting brightness.

In the embodiment, second image data obtained by the second image sensor 2B is sent to the second controller 3B. The second controller 3B calculates an average illuminance of the entire lighting space from the second image data. Data on the calculated average illuminance is sent from the second controller 3B to the first controllers 3A and 3C.

Pieces of first image data obtained by the first image sensors 2A and 2C are sent to the first controllers 3A and 3C, respectively. The first controllers 3A and 3C identifies in which of the subspaces the shadow S is extending from the person H by performing control similar to that in Embodiment 2, based on the first image data. The first controllers 3A and 3C respectively adjust the dimming rates of the lighting units 1A, 1B, 1C, and 1D and the lighting units 1E, 1F, 1G, and 1H, based on data on the average illuminance and data capable of identifying the subspace in which the shadow S is extending from the person H.

In the embodiment, the first controller 3A, for example, increases only the dimming rate of the lighting unit 1B associated with the subspace SPB. In this case, the first controller 3A adjusts the dimming rates of the lighting units 1A, 1C, and 1D associated respectively with the subspaces SPA, SPC, and SPD such that a predetermined illuminance necessary for the person H is achieved. To this end, control signals outputted by the first controller 3A are sent to the lighting units 1A, 1B, 1C, and 1D in this order, the lighting units 1A, 1B, 1C, and 1D connected in series via one communication line.

Moreover, the first controller 3C adjusts the dimming rates of the lighting units 1E, 1F, 1G, and 1H associated respectively with the subspaces SPE, SPF, SPG, and SPH such that the predetermined illuminance necessary for the person H is achieved. In this case, control signals outputted by the first controller 3C are sent to the lighting units 1E, 1F, 1G, and 1H in this order, the lighting units 1E, 1F, 1G, and 1H connected in series via one communication line.

The respective positions of the first controller 3A and the first controller 3C of the first lighting control units and the position of the second controller 3B of the second lighting control unit are determined in advance based on a design such that the controllers are located away from one another by appropriate distances.

The first controllers 3A and 3C each have a person determiner 31 and a shadow determiner 32 as illustrated in FIG. 6. Also in the embodiment, as in Embodiment 2, the person determiners 31 determine whether the person H is staying in the lighting space, by using the first image data which is obtained from the first image sensors 2A and 2C as a portion of the image data. Moreover, the shadow determiners 32 determine whether the shadow S is extending from the person H in the lighting space. Thereafter, when determining that the shadow S is extending from the person H, the shadow determiners 32 identify in which of the subspaces SPA, SPB, SPC, SPD, SPE, SPF, SPG, and SPH the shadow S is extending from the person H.

In the embodiment, the second controller 3B has an illuminance calculator 34 as illustrated in FIG. 6. The illuminance calculator 34 included in the second controller 3B calculates the average illuminance by using the second image data which is obtained from the second image sensor 2B as another portion of the image data.

The first controllers 3A and 3C and the second controller 3B work together. Specifically, the first controllers 3A and 3C and the second controller 3B use the data on the subspace identified to have the shadow S extending from the person H and the data on the average illuminance. The first controllers 3A and 3C and the second controller 3B thereby increase the dimming rate in the subspace identified to have the shadow S extending from the person H. In the embodiment, the dimming rate of the lighting unit 1B associated with the subspace SPB is increased.

In the lighting control system 10 of the embodiment, the identification of the subspace in which the shadow S extends from the person H and the calculation of the average illuminance of the lighting space can be executed by the controllers which are physically separated from one another. Accordingly, control load of each of the plurality of controllers 3A, 3B, and 3C can be reduced. Particularly, in the case where there are many lighting units, information which is too many to be processed by one controller can be processed by a plurality of controllers working together.

Moreover, the first image sensors 2A and 2C and the second image sensor 2B can be installed at separate positions. Accordingly, the number and positions of the image sensors can be varied depending on the necessary accuracy of the image data. Hence, the number and positions of the image sensors to be installed can be set to suit the purpose and usage.

As illustrated in FIG. 9, in the lighting control system 10, the lighting units 1A, 1B, 1C, and 1D may be physically aligned in a row and connected in series via one communication line. Moreover, in the lighting control system 10, the lighting units 1E, 1F, 1G, and 1H may be physically aligned in a row and connected in series via one communication line.

A characteristic configuration of the lighting control system 10 in the embodiment and effects obtained by this characteristic configuration are described below.

(1) The lighting control system 10 includes the lighting unit 1, the imaging unit 2, and the controller 3. The lighting unit 1 emits light to the lighting space SP. The imaging unit 2 obtains the image data of the lighting space SP. The controller 3 controls the lighting unit 1 based on the image data obtained by the imaging unit 2. The controller 3 includes the person determiner 31, the shadow determiner 32, and the dimmer 33. The person determiner 31 determines whether the person H is staying in the lighting space SP, based on the image data. The shadow determiner 32 determines whether the shadow S is extending from the person H, based on the image data when the person determiner 31 determines that the person H is staying in the lighting space SP. The dimmer 33 increases the dimming rate of the lighting unit 1 when the shadow determiner 32 determines that the shadow S is extending from the person H.

The configuration described above can suppress the adverse effect of the shadow S of the person H that objects are less visible.

(2) The controller 3 may further include the illuminance calculator 34 which calculates the average illuminance of the illumination surface in the lighting space SP, based on the image data. In this case, the dimmer 33 may adjust the dimming rate of the lighting unit 1 such that the average illuminance becomes the predetermined value necessary for the person H. Under this condition, the dimmer 33 may increase the dimming rate of the lighting unit 1 when the shadow determiner 32 determines that the shadow is extending from the person H.

The configuration described above can maintain the average illuminance of the illumination surface in the lighting space SP at the predetermined value necessary for the person H when no shadow S is extending from the staying person H.

(3) The lighting control system 10 includes the plurality of lighting units 1A, 1B, 1C, and 1D and the imaging unit 2. The plurality of lighting units 1A, 1B, 1C, and 1D each emits the light to corresponding one of the plurality of subspaces SPA, SPB, SPC, and SPD constituting the lighting space SP. The imaging unit 2 obtains image data of the lighting space. The controller 3 controls the lighting units 1A, 1B, 1C, and 1D based on the image data obtained by the imaging unit 2. The controller 3 includes the data storage 35, the person determiner 31, the shadow determiner 32, and the dimmer 33. The data storage 35 stores the association data in which the plurality of lighting units 1A, 1B, 1C, and 1D are associated with the plurality of subspaces SPA, SPB, SPC, and SPD, respectively. The person determiner 31 determines whether the person H is staying in the lighting space, based on the image data. The shadow determiner 32 determines whether the shadow S is extending from the person H, based on the image data when the person determiner 31 determines that the person H is staying in the lighting space. Then, when determining that the shadow S is extending from the person H, the shadow determiner 32 identifies in which of the plurality of subspaces SPA, SPB, SPC, and SPD the shadow S is extending from the person H. The dimmer 33 increases the dimming rate of the corresponding one of the plurality of lighting units 1A, 1B, 1C, and 1D which emits light to the subspace SPB identified by the shadow determiner 32, based on the association data. Thereby, the dimmer 33 increases the brightness of the light emitted from the corresponding one of the plurality of lighting units 1A, 1B, 1C, and 1D.

The configuration described above can suppress the adverse effect of the shadow S of the person H. Moreover, it is possible to increase only the dimming rate of lighting unit 1 emitting light to the subspace SPB in which the shadow S is extending from the person H. Accordingly, it is possible to prevent unnecessary power consumption caused by increasing the dimming rates of the lighting units 1 emitting light to the subspaces SPA, SPC, and SPD in which no shadow S is extending from the person H.

(4) The controller 3 may include the illuminance calculator 34 which calculates the average illuminance of the illumination surface in each of the plurality of subspaces SPA, SPB, SPC, and SPD, based on the image data. The dimmer 33 adjusts the dimming rates of the plurality of lighting units 1A, 1B, 1C, and 1D such that the average illuminance of the illumination surface in each of the plurality of subspaces SPA, SPB, SPC, and SPD becomes the predetermined value necessary for the person H. Under this condition, the dimmer 33 may increase the dimming rate of the lighting unit 1 emitting light to the subspace SPB identified to have the shadow S extending from the person H.

The configuration described above can maintain the average illuminances of the illumination surfaces in the subspaces SPA, SPB, SPC, and SPD in which no shadow S is extending from the staying person H, at the predetermined value necessary for the person H.

(5) The imaging unit 2 may include the first image sensors 2A and 2C and the second image sensor 2B. The controller 3 may include the first controllers 3A and 3C and the second controller 3B. The first controllers 3A and 3C may each have the person determiner 31 and the shadow determiner 32. In this case, the person determiners 31 determine whether the person H is staying, by using the first image data which is obtained from the first image sensors 2A and 2C as a portion of the image data. Moreover, the shadow determiners 32 determine whether the shadow S is extending from the person H. Thereafter, when determining that the shadow S is extending from the person H, the shadow determiner 32 identifies in which of the subspaces SPA, SPB, SPC, and SPD the shadow S is extending from the person H. The second controller 3B may have the illuminance calculator 34. The illuminance calculator 34 calculates the average illuminance by using the second image data which is obtained from the second image sensor 2B as another portion of the image data. The first controllers 3A and 3C and the second controller 3B work together. Specifically, the first controllers 3A and 3C and the second controller 3B use the data on the subspace SPB identified to have the shadow S extending from the person H and the data on the average illuminance. The first controllers 3A and 3C and the second controller 3B thereby increase the dimming rate of the lighting unit 1 emitting light to the subspace SPB identified to have the shadow S extending from the person H.

The configuration described above can reduce the control load of each of the controllers 3A, 3B, and 3C.

(6) The light control unit (2,3) controls the lighting unit 1 to emit the light to the lighting space SP. The light control unit (2,3) includes the imaging unit 2 and the controller 3. The imaging unit 2 obtains image data of the lighting space SP. The controller 3 controls the lighting unit 1 based on the image data obtained by the imaging unit 2. The controller 3 controls the light unit 1 so as to increase the brightness of the light emitted from the lighting unit 1, in the case where the controller 3 determines based on the image data that the person H is staying in the lighting space SP and that the shadow S extends from the person H.

In the present disclosure, all or a part of any of unit, device, part, portion, or any of functional blocks in the block diagrams shown in FIGS. 3 and 6 may be implemented as one or more of electronic circuits including, but not limited to, a semiconductor device, a semiconductor integrated circuit (IC) or an LSI. The LSI or IC can be integrated into one chip, or also can be a combination of plural chips. For example, functional blocks other than a memory may be integrated into one chip. The name used here is LSI or IC, but it may also be called system LSI, VLSI (very large scale integration), or ULSI (ultra large scale integration) depending on the degree of integration. A Field Programmable Gate Array (FPGA) that can be programmed after manufacturing an LSI or a reconfigurable logic device that allows reconfiguration of the connection or setup of circuit cells inside the LSI can be used for the same purpose.

Further, it is also possible that all or a part of the functions or operations of the unit, device, part, portion or functional blocks are implemented by executing software (one or more programs). In such a case, the software is recorded on one or more non-transitory recording media such as a ROM, an optical disk or a hard disk drive, and when the software is executed by a processor, the software causes the processor together with peripheral devices to execute the functions specified in the software. A system or apparatus may include such one or more non-transitory recording media on which the software is recorded and a processor together with necessary hardware devices such as an interface.

What is claimed is:

1. A lighting control system, comprising:
a lighting unit that emits light to a lighting space;
an imaging unit that obtains image data of the lighting space; and
a controller that controls the lighting unit based on the image data obtained by the imaging unit, wherein
the controller includes:
a person determiner that determines whether a person is staying in the lighting space, based on the image data;
a shadow determiner that, when the person determiner determines that the person is staying in the lighting space, determines whether a shadow extends from the person, based on the image data; and
a dimmer that, when the shadow determiner determines that the shadow extends from the person, increases brightness of the light emitted from the lighting unit by increasing a dimming rate of the lighting unit.

2. The lighting control system according to claim 1, wherein
the controller further includes an illuminance calculator that calculates an average illuminance of an illumination surface in the lighting space, based on the image data, and
under a condition in which the dimming rate of the lighting unit is adjusted by the dimmer such that the average illuminance takes a predetermined value necessary for the person, the dimmer increases the dimming rate of the lighting unit if the shadow determiner determines that the shadow extends from the person.

3. A lighting control system comprising:
a plurality of lighting units, each emitting light to corresponding one of a plurality of subspaces constituting a lighting space;
an imaging unit that obtains image data of the lighting space;
a controller that controls the plurality of lighting units based on the image data obtained by the imaging unit, wherein
the controller includes:
a data storage that stores association data in which the plurality of lighting units are associated with the plurality of subspaces, respectively,
a person determiner that determines whether a person is staying in the lighting space, based on the image data,
a shadow determiner that, when the person determiner determines that the person is staying in the lighting space, determines whether a shadow extends from the person, based on the image data and then, when determining that the shadow extends from the person, identifies in which of the plurality of subspaces the shadow extend from the person, based on the image data, and
a dimmer that increases a dimming rate of a corresponding one of the plurality of lighting units emitting light to the subspace identified by the shadow determiner from among the plurality of subspaces, based on the association data, and thereby, increases brightness of the light emitted from the corresponding one of the plurality of lighting units.

4. The lighting control system according to claim 3, wherein:
the controller further includes an illuminance calculator that calculates an average illuminance of an illumination surface in each of the plurality of subspaces, based on the image data, and
under a condition in which the dimming rates of the plurality of lighting units are adjusted by the dimmer such that the average illuminance of the illumination surface in each of the plurality of subspaces becomes a predetermined value necessary for the person, the dimmer increases the dimming rate of the lighting unit emitting light to the subspace identified to have the shadow extending from the person.

5. The lighting control system according to claim 4, wherein
the imaging unit includes a first image sensor and a second image sensor,
the controller includes a first controller and a second controller,
the first controller includes the person determiner and the shadow determiner,
the person determiner determines whether the person is staying by using first image data which is obtained from the first image sensor as a portion of the image data,
the shadow determiner determines whether the shadow extends from the person by using the first image data and then, when determining that the shadow extends from the person, identifies in which of the plurality of subspaces the shadow extends from the person,
the second controller includes the illuminance calculator,
the illuminance calculator calculates the average illuminance by using second image data which is obtained from the second image sensor as another portion of the image data, and
the first controller and the second controller work together to increase the dimming rate of the subspace identified to have the shadow extending from the person, by using data on the subspace identified to have the shadow extending from the person and data on the average illuminance.

6. A light control unit that controls a lighting unit to emit light to a lighting space, wherein the light control unit comprises:
an imaging unit that obtains image data of the lighting space; and
a controller that controls the lighting unit based on the image data obtained by the imaging unit, wherein
the controller controls the light unit so as to increase brightness of the light emitted from the lighting unit, in a case where the controller determines based on the image data that a person is staying in the lighting space and that a shadow extends from the person.
